(19) United States
(12) Patent Application Publication
(10) Pub. No.: US 2025/0272074 A1
(43) Pub. Date: Aug. 28, 2025

(54) METHOD AND SYSTEM FOR CONTINUOUS SOFTWARE IMPROVEMENT

(71) Applicant: HCL Technologies Limited, New Delhi (IN)

(72) Inventors: Prathameshwar Pratap Singh, Noida (IN); Yogesh Gupta, Noida (IN); Dhanyamraju S U M Prasad, Hyderabad (IN)

(21) Appl. No.: 19/034,708

(22) Filed: Jan. 23, 2025

(30) Foreign Application Priority Data
Feb. 27, 2024 (IN) 202411014448

(51) Int. Cl. G06F 8/41

(52) U.S. Cl. CPC G06F 8/443

(57) ABSTRACT

This disclosure relates to a method and a system method of continuous software improvement. The method includes receiving a plurality of code files related to a plurality of functionalities in a software development lifecycle from a plurality of sources; selecting a code file from the plurality of code files; analyzing the code file based on a plurality of predefined parameters, through a predefined analysis technique and a generative Artificial Intelligence (AI) model; identifying one or more potential anomalies in the code file based on the analysis; resolving one or more potential anomalies through at least one of a refactorization technique, a clone detection technique, or a remediation technique; generating an optimized code file in response to resolving the one or more potential anomalies; and rendering the optimized code file as a real-time recommendation to a user.

### DESCRIPTION

### Technical Field

This disclosure relates generally to software development, and more particularly to method and system for method of continuous software improvement.

### Background

In software industry, maintaining high-quality code is crucial. It may be required to ensure code sustainability and maintainability when complexity of software applications increases. This helps prevent performance degradation, security vulnerabilities, and escalating development costs. These issues may impact overall success of a software project. Further, traditional code maintenance methodologies often rely on manual and rule-based processes that are labor-intensive, error-prone, and inconsistent, leading to suboptimal code quality. As a scale and complexity of software projects increases, challenges associated with maintaining and improving code quality become more pronounced.

Various existing systems provide automated solution for continuous software code maintainance and sustenance. However, implementing such solutions poses challenges. It is difficult to integrate automated code maintenance tools into current development processes and environments without causing problems, as this requires compatibility with a variety of Integrated Development Environments (IDEs) and version control systems. Furthermore, a challenge is to ensure that automated procedures accurately identify and rectify vulnerabilities without creating new issues or disrupting prevailing development practices.

The present invention is directed to overcome one or more limitations stated above or any other limitations associated with the known arts.

### SUMMARY

In one embodiment, a method of continuous software improvement is disclosed. In one example, the method may include receiving a plurality of code files related to a plurality of functionalities in a software development lifecycle from a plurality of sources. It should be noted that each of the plurality of code files may include code snippets. The method may include selecting a code file from the plurality of code files. It should be noted that the code file may be related to a functionality of the plurality of functionalities. The method may further include analyzing the code file based on a plurality of predefined parameters, through a predefined analysis technique and a generative Artificial Intelligence (AI) model. The plurality of pre-defined parameters may include a documentation scrutiny, a code complexity, an impact of code change, and a security compliance verification. The method may include identifying one or more potential anomalies in the code file based on the analysis. The method may further include resolving the one or more potential anomalies through at least one of a refactorization technique, a clone detection technique, or a remediation technique. The method may include generating an optimized code file in response to resolving the one or more potential anomalies. The method may also include rendering the optimized code file as a real-time recommendation to a user.

In one embodiment, a system of continuous software improvement is disclosed. In one example, the system may include a processor and a memory communicatively coupled to the processor. The memory may store processor-executable instructions, which, on execution, may cause the processor to receive a plurality of code files related to a plurality of functionalities in a software development lifecycle from a plurality of sources. It should be noted that each of the plurality of code files may include code snippets. The processor-executable instructions, on execution, may further cause the processor to select a code file from the plurality of code files. It should be noted that the code file may be related to a functionality of the plurality of functionalities. The processor-executable instructions, on execution, may further cause the processor to analyze the code file based on a plurality of predefined parameters, through a predefined analysis technique and a generative Artificial Intelligence (AI) model. The plurality of pre-defined parameters may include a documentation scrutiny, a code complexity, an impact of code change, and a security compliance verification. The processor-executable instructions, on execution, may further cause the processor to identify one or more potential anomalies in the code file based on the analysis. The processor-executable instructions, on execution, may further cause the processor to resolve the one or more potential anomalies through at least one of a refactorization technique, a clone detection technique, or a remediation technique. The processor-executable instructions, on execution, may further cause the processor to generate an optimized code file in response to resolving the one or more potential anomalies. The processor-executable instructions, on execution, may further cause the processor to render the optimized code file as a real-time recommendation to a user.

In one embodiment, a non-transitory computer-readable medium storing computer-executable instructions for continuous software improvement is disclosed. In one example, the stored instructions, when executed by a processor, may cause the processor to perform operations including receiving a plurality of code files related to a plurality of functionalities in a software development lifecycle from a plurality of sources. It should be noted that each of the plurality of code files may include code snippets. The operations may include selecting a code file from the plurality of code files. It should be noted that the code file may be related to a functionality of the plurality of functionalities. The operations may further include analyzing the code file based on a plurality of predefined parameters, through a predefined analysis technique and a generative Artificial Intelligence (AI) model. The plurality of pre-defined parameters may include a documentation scrutiny, a code complexity, an impact of code change, and a security compliance verification. The operations may also include identifying one or more potential anomalies in the code file based on the analysis. The operations may further include resolving the one or more potential anomalies through at least one of a refactorization technique, a clone detection technique, or a remediation technique. The operations may include generating an optimized code file in response to resolving the one or more potential anomalies. The operations may further include rendering the optimized code file as a real-time recommendation to a user.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for continuous software improvement, in accordance with some embodiments of the present disclosure.

FIG. 2 illustrates a functional block diagram of various modules within a memory of a server configured to continuous software improvement, in accordance with some embodiments.

FIG. 3 illustrates a flow diagram of an exemplary process for continuous software improvement, in accordance with some embodiments of the present disclosure.

FIG. 4 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

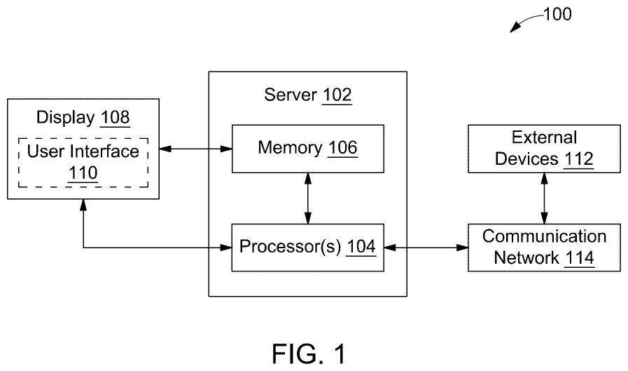

Referring now to FIG. 1, an exemplary system 100 of continuous software improvement is illustrated, in accordance with some embodiments of the present disclosure. The system 100 employs generative Artificial Intelligence (AI), and advanced software engineering techniques to identify, analyze, and resolve issues, ensuring superior code quality, performance, and maintainability. Further, the system 100 helps automate a process of identifying, analyzing, and resolving issues, enabling developers to focus on feature development.

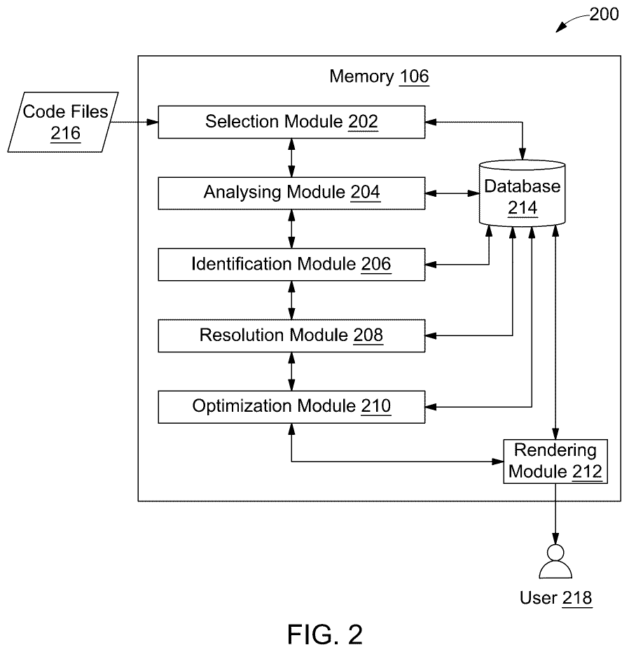

The system 100 may include a server 102. Examples of the server 102 may include, but are not limited to, a desktop, an application server, a laptop, a notebook, a netbook, a tablet, a smartphone, a mobile phone, or any other computing device. The server 102 may perform continuous software improvement. As will be described in greater detail in conjunction with FIGS. 2-4, the server 102 may perform various operations including receiving code files, storing the code files, selecting a code file, analyzing the code file, scanning the code file, generating summaries, comments, and dependency trees, identifying potential anomalies in the code file, resolving the potential anomalies, generating an optimized code file, and rendering the optimized code and real-time recommendations.

In some embodiments, the server 102 may include one or more processors 104 and a memory 106. The memory 106 may include a database (not shown in FIG. 1). Further, the memory 106 may store instructions that, when executed by the one or more processors 104, cause the one or more processors 104 to perform continuous software improvement. The memory 106 may also store various data (for example code files, code summaries, dependency trees, a feedback, code snippets, information related to various parameters such as documentation scrutiny, a code complexity, an impact of code change, and a security compliance verification, optimized code files, and the like) that may be captured, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.)

The system 100 may further include a display 108. The system 100 may interact with a user via a user interface 110 accessible via the display 108. The system 100 may also include one or more external devices 112. The one or more external devices 112 may referred to as a plurality sources of code files, in accordance with some embodiments of the disclosure. In some embodiments, the server 102 may interact with the one or more external devices 112 over a communication network 114 for sending or receiving various data. By way of an example, the server 102 may receive the plurality of code files or a user feedback from the external devices 112 via the communication network 114. By way of another example, the server 102 may send the optimised code file to the external devices 112.

The communication network 114, for example, may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS). The external devices 112 may include, but may not be limited to, a remote server, a digital device, a desktop, a laptop, a notebook, a netbook, a tablet, a smartphone, a mobile phone, or another computing system.

Referring now to FIG. 2, a functional block 200 diagram of various modules within the memory 106 of the server 102 configured to perform continuous software improvement, in accordance with some embodiments of the present disclosure. FIG. 2 is explained in conjunction with FIG. 1. To perform continuous software improvement, the memory 106 may include a selection module 202, an analyzing module 204, an identification module 206, a resolution module 208, an optimization module 210 and a rendering module 212. The memory 106 further includes a database 214 for storing various data and intermediate results generated by the modules 202-212.

In some embodiments, the selection module 202 may receive a plurality of code files 216 related to a plurality of functionalities in a software development lifecycle. The plurality of code files 216 may be received from a plurality of sources. This means the plurality of code files 216 may be in same or different languages, formats, sizes, and complexities. As will be appreciated to an ordinary person skilled in the art, code files include instructions written in a programming language. The plurality of sources may include, but is not limited to, local files, code repositories, cloud-based repositories, collaborative platforms, documentation platforms, continuous integration or delivery systems, knowledge bases, and document stores. Alternatively, in some embodiments, the memory 106 may include a receiving module (not shown in FIG. 2) that may receive the plurality of code files 216 from the plurality of sources. Further, the receiving module may send the plurality of code files 216 to the database 214. In other words, the plurality of code files 216 may be stored in the database 214. It should be noted that each of the plurality of code files 216 includes code snippets. The code snippets may be small sections of code within the plurality of code files 216. The code snippets may represent specific functionalities or actions within the software. The plurality of code files 216 may be stored in at least one of a plurality of pre-defined formats. In one embodiment, the plurality of pre-defined formats may include a searchable format for a text-based analysis, enabling efficient text-based search and retrieval of relevant code snippets and documents. In another embodiment, the plurality of pre-defined formats may include an embedded format such as embedding vectors for a similarity and clustering analysis.

Further, in some embodiments, the selection module 202 may be configured to access, read, and ingest the plurality of code files 216 from the plurality of sources, for example from local file systems such as a user's local computer (i.e., a computing device) or server, various code repositories such as Team Foundation Server® (TFS) or GitHub®, various document stores such as a local file system, OneDrive®, and SharePoint®, and the like.

In some embodiments, the selection module 202 may select a code file from the plurality of code files 216 received from the plurality of sources. Alternatively, when the plurality of code files 216 are stored in the database 214, the selection module 202 may select the code file and then retrieve the code file from the database 214. In some embodiments, the code file may be selected based on a requirement of a user 218. Examples of the user 218 may include, but are not limited to, software developers, editors, and the like. In some embodiments, each of the plurality of code files 216 may be selected in a predefined sequential manner or contemporaneously and further operations may be performed. The code file may be related to a functionality of the plurality of functionalities. The functionality of the code file may correspond to a task, or an operation performed using a particular code within the code file. In other words, the functionality may be referred to as a purpose or a role of the code within the code file. The selection module 202 may be communicatively coupled to the analyzing module 204.

The analyzing module 204 may be configured to analyze the code file based on a plurality of predefined parameters. The plurality of pre-defined parameters may include a documentation scrutiny, a code complexity, an impact of code change, and a security compliance verification. The documentation scrutiny corresponds to analyzation of documentation strings within the code file with respect to standard guidelines. In other words, the documentation scrutiny is analyzation of documentation strings (i.e., docstrings) within the code file to ensure proper documentation and adherence to best practices. The code complexity corresponds to a level of intricacy in understanding, maintaining, and modifying the code file. The parameter code complexity helps assess complexity of the code file to identify areas where simplification and optimization may be beneficial. The impact of code change corresponds to a potential effect of modification in the code file on other code files. This parameter helps evaluate the potential impact of changes in the code file on overall system, helping developers make informed decisions when modifying code. The security compliance verification corresponds to verification of the code file for potential security vulnerabilities and licenses of software components used in the code file.

The analyzing module 204 may employ a predefined analysis technique and a generative Artificial Intelligence (AI) model to analyze the code file. The predefined analysis technique may include at least one of a static analysis technique or a dynamic analysis technique. The static analysis technique includes examining the code file before running the code file. Examples of the static analysis may include, but are not limited to, Syntex checking, control flow analysis, data flow analysis, code metrics analysis, and security vulnerability analysis. The dynamic analysis technique includes examining the code file while running the code within the code file or during code execution. Examples of the dynamic techniques may include, but are not limited to, testing, proofing, code coverage analysis, memory leak detection, and dynamic security analysis. Further, the generative AI model may be configured to perform automated code analysis of the code file. The generative AI model may be configured for automated pattern recognition.

In some embodiments, to analyze the code file, the analyzing module 204 may scan the code file. Further, the analyzing module 204 may generate one or more of code summaries, comments, and dependency trees based on the scanning. In some embodiments, the generative AI model may be used to generate the code summaries, comments, and dependency trees. Also, in some embodiments, the generative AI model may generate information related to a list potential issues such as bugs, security vulnerabilities, code clones, and performance bottlenecks. The analyzing module 204 may be operatively coupled to the identification module 206.

Further, the identification module 206 may be configured to identify one or more potential anomalies in the code file based on the analysis performed by the analyzing module 204. The one or more potential anomalies includes code clones, performance bottlenecks, bugs, security vulnerabilities, concurrency issues, memory leaks, unused variables, and resource contentions. For example, in one embodiment, the identification module 206 may identify a code clone in the code file. The code clone may be referred to as duplication of code in the code file or duplicated code snippets. The performance bottlenecks are areas of the code that significantly slow down execution of the code. The performance bottlenecks may affect overall performance and responsiveness of the system. Further, bugs are errors or flaws in the code that cause a corresponding program to behave unexpectedly or produce incorrect results. For example, a bug may be a null pointer dereference, where a program attempts to access a memory address that is null, leading to a crash. The security vulnerabilities are weaknesses in the code that may be exploited by attackers to compromise security of the system. Further, the concurrency issues correspond to issues that arise when multiple threads or processes access shared resources concurrently, leading to unexpected behavior or data corruption. The memory leaks may occur when a program allocates memory but fails to release it after it is no longer needed, leading to a gradual depletion of available memory. The unused variables are variables that are declared but never used or accessed within the code. The resource contentions may occur when multiple parts of the code compete for the same shared resources, leading to contention and potential performance degradation. The identification module 206 may be communicatively coupled to the resolution module 208.

The resolution module 208 may be configured to resolve the one or more potential anomalies. The resolution module 208 may utilize at least one of a refactorization technique, a clone detection technique, or a remediation technique, to resolve the one or more potential anomalies. The refactorization technique may include restructuring of an existing code file (i.e., the code file). The refactorization technique may improve its internal structure without changing its external behavior. The refactorization technique may not involve adding new features or fixing bugs but focuses on enhancing the internal structure of the code. The refactorization technique may improve code readability, maintainability, and performance. By way of an example, consider a scenario where software project includes a long and complex function that performs multiple tasks. Refactoring this function by breaking the function down into smaller, more focused functions may improve code readability and make it easier to understand and maintain.

The clone detection technique may be configured to identify and categorize duplicated or similar pieces of the code file (i.e., the code snippets). The resolution module 208 may analyze codebase to identify sections of the code that are identical or similar through the clone detection technique. These duplicated code fragments or code clones may lead to maintenance issues and increase a risk of bugs. The clone detection technique may help identify and eliminate the code clones by refactoring duplicated code into reusable components or shared libraries. By way of an example, consider a scenario where a project includes multiple functions that perform similar tasks but are implemented separately. In such a case, these duplicated code clones may be identified, and it may be suggested to consolidate functionality into reusable components or library. The remediation technique may apply automated code fixes to address identified issues, such as the bugs, the security vulnerabilities, and the performance bottlenecks in the code file. The resolution module 208 may be operatively coupled to the optimization module 210.

Further, optimization module 210 may be configured to generate an optimized code file in response to resolving the one or more potential anomalies in the code file. The optimized code file may be free from the one or more potential issues. The optimized code file provides enhanced code quality, usability, performance, and readability. The optimization module 210 may be communicatively coupled to the rendering module 212. Further, the rendering module 212 may be configured to render the optimized code file as a real-time recommendation to the user 218. The user 218 may be provided seamless access to the optimized code file. Further, in some embodiments, the a real-time feedback may be received from a user 218 corresponding to the optimized code file during software development in response to rendering the optimized code file.

In some embodiments, the server 102 may be integrated with Integrated Development Environment (IDE) extensions, providing seamless access to code analysis results and receiving real-time feedback during software development. For example, these plugins enable integration with web browsers, allowing developers to access the code analysis results and provide the real-time feedback while working on web-based code editors and development environments. This integration allows for real-time recommendations and fixes, enabling the user 218 to address code issues as they arise during the development process.

It should be noted that all such aforementioned modules 202-212 may be represented as a single module or a combination of different modules. Further, as will be appreciated by those skilled in the art, each of the modules 202-212 may reside, in whole or in parts, on one device or multiple devices in communication with each other. In some embodiments, each of the modules 202-212 may be implemented as dedicated hardware circuit comprising custom application-specific integrated circuit (ASIC) or gate arrays, off-the-shelf semiconductors such as logic chips, transistors, or other discrete components. Each of the modules 202-212 may also be implemented in a programmable hardware device such as a field programmable gate array (FPGA), programmable array logic, programmable logic device, and so forth. Alternatively, each of the modules 202-212 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for continuous software improvement. For example, the exemplary system 100 and the associated server 102 may perform continuous software improvement by the processes discussed herein. In particular, as will be appreciated by those of ordinary skill in the art, control logic and/or automated routines for performing the techniques and steps described herein may be implemented by the system 100 and the associated computing device 102, 200 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

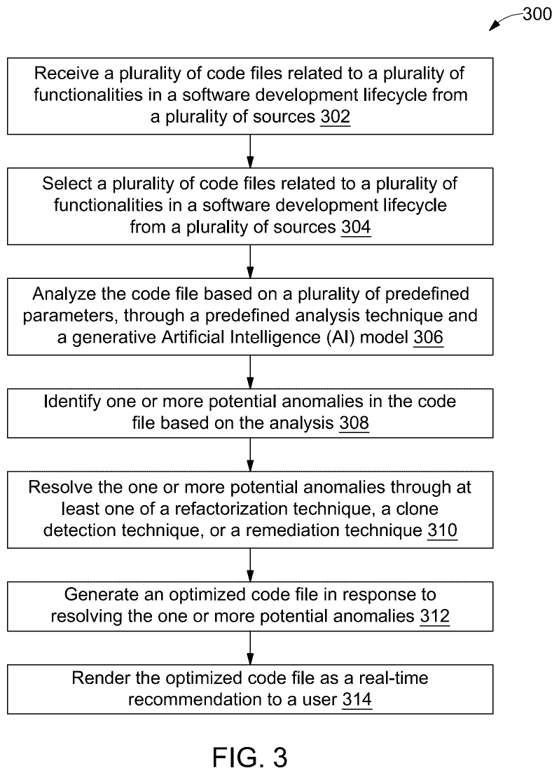

Referring now to FIG. 3, an exemplary process 300 for continuous software improvement is depicted via a flowchart, in accordance with some embodiments of the present disclosure. FIG. 3 is explained in conjunction with FIGS. 1-2. Each step of the process 300 may be implemented by the server 102.

At step 302, a plurality of code files (such as the plurality of code files 216) related to a plurality of functionalities in a software development lifecycle may be received from a plurality of sources. Each of the plurality of code files may include code snippets. The code snippets are small sections of code within the plurality of code files. The code snippets may represent specific functionalities or actions within the software. The plurality of code files may be in same or different languages, formats, sizes, and complexities as the plurality of code files are received from different sources. It should be noted that the plurality of sources may include local files, code repositories, cloud-based repositories, collaborative platforms, documentation platforms, continuous integration or delivery systems, knowledge bases, and document stores. Alternatively, in some embodiments, the plurality of sources may be accessed to retrieve the plurality of code files. For example, local file systems such as a user's local computer (i.e., a computing device) or server, various code repositories such as Team Foundation Server® (TFS) or GitHub®, various document stores such as a local file system, OneDrive®, and SharePoint®, and the like, may be accessed.

The plurality of code files may be stored in at least one of a plurality of pre-defined formats. The plurality of pre-defined formats may include a searchable format for a text-based analysis and an embedded format (such as embedded vectors) for a similarity and clustering analysis. Storing the plurality of code files in the searchable format enables efficient text-based search and retrieval of relevant code snippets and documents.

At step 304, a code file from the plurality of code files may be selected. This step may be performed using a selection module (such as the selection module 202). It should be noted that the code file may be related to a functionality of the plurality of functionalities. In some embodiments, the code file may be selected based on a requirement of a user (for example the user 218). Examples of the user may include, but are not limited to, software developers, editors, and the like. In some embodiments, each of the plurality of code files may be selected in a predefined sequential manner or contemporaneously and further steps may be performed. The code file may be related to a functionality of the plurality of functionalities. The functionality of the code file may correspond to a task, or an operation performed using a particular code within the code file. In other words, the functionality refers to a purpose or a role of the code within the code file.

At step 306, the code file may be analyzed based on a plurality of predefined parameters, through a predefined analysis technique and a generative Artificial Intelligence (AI) model. This step is performed using an analyzing module (such as the analyzing module 204). It should be noted that the plurality of pre-defined parameters may include a documentation scrutiny, a code complexity, an impact of code change, and a security compliance verification. The documentation scrutiny may correspond to analyzation of documentation strings within the code file with respect to standard guidelines. In other words, the documentation scrutiny is analyzation of documentation strings (i.e., docstrings) within the code file to ensure proper documentation and adherence to best practices. Further, the code complexity may correspond to a level of intricacy in understanding, maintaining, and modifying the code file. The parameter code complexity helps to assess complexity of the code file to identify areas where simplification and optimization may be beneficial. The impact of code change may correspond to a potential effect of modification in the code file on other code files. This parameter helps evaluate the potential impact of changes in the code file on overall system, helping developers make informed decisions when modifying code. The security compliance verification may correspond to verification of the code file for potential security vulnerabilities and licenses of software components used in the code file.

With regards to the predefined analysis techniques, at least one of a static analysis technique or a dynamic analysis technique may be used. The static analysis technique includes examining the code file before running the code file. Examples of the static analysis may include, but are not limited to, Syntex checking, control flow analysis, data flow analysis, code metrics analysis, and security vulnerability analysis. The dynamic analysis technique includes examining the code file while running the code within the code file or during code execution. Examples of the dynamic techniques may include, but are not limited to, testing, proofing, code coverage analysis, memory leak detection, and dynamic security analysis. Further, the generative AI model may be configured to perform automated code analysis of the code file. The generative AI model may be configured for automated pattern recognition.

In some embodiment, in order to analyze the code file, initially, the code file may be scanned. Once the code file is scanned, one or more of summaries, comments, and dependency trees may be generated based on the scanning. In some embodiments, the generative AI model may be used to generate the code summaries, comments, and dependency trees. Also, in some embodiments, the generative AI model may generate information related to a list potential issues such as bugs, security vulnerabilities, code clones, and performance bottlenecks.

At step 308, one or more potential anomalies may be identified in the code file based on the analysis using an identification module (such as the identification module 206). It should be noted that one or more potential anomalies may include code clones, performance bottlenecks, bugs, security vulnerabilities, concurrency issues, memory leaks, unused variables, and resource contentions. In one example, a code clone may be identified in the code file. The code clone may be referred to as duplication of code in the code file or duplicated code snippets. The performance bottlenecks are areas of the code that significantly slow down execution of the code. The performance bottlenecks may affect overall performance and responsiveness of the system. Further, bugs are errors or flaws in the code that cause a corresponding program to behave unexpectedly or produce incorrect results. For example, a bug may be a null pointer dereference, where a program attempts to access a memory address that is null, leading to a crash. The security vulnerabilities are weaknesses in the code that may be exploited by attackers to compromise security of the system. Further, the concurrency issues correspond to issues that arise when multiple threads or processes access shared resources concurrently, leading to unexpected behavior or data corruption. The memory leaks may occur when a program allocates memory but fails to release it after it is no longer needed, leading to a gradual depletion of available memory. The unused variables are variables that are declared but never used or accessed within the code. The resource contentions may occur when multiple parts of the code compete for the same shared resources, leading to contention and potential performance degradation.

Thereafter, at step 310, the one or more potential anomalies may be resolved using a resolution module (such as the resolution module 208). At least one of a refactorization technique, a clone detection technique, or a remediation technique be used for resolving the one or more potential anomalies. The refactorization technique may include restructuring of an existing code file (i.e., the code file). The refactorization technique may improve its internal structure without changing its external behavior. The refactorization technique may not involve adding new features or fixing bugs but focuses on enhancing the internal structure of the code. The refactorization technique may improve code readability, maintainability, and performance. By way of an example, consider a scenario where software project includes a long and complex function that performs multiple tasks. Refactoring this function by breaking the function down into smaller, more focused functions may improve code readability and make it easier to understand and maintain.

The clone detection technique may be configured to identify and categorize duplicated or similar pieces of the code file (i.e., the code snippets). For example, in some embodiments, codebase may be analyzed to identify sections of the code that are identical or similar through the clone detection technique. These duplicated code fragments or code clones may lead to maintenance issues and increase a risk of bugs. The clone detection technique may help identify and eliminate the code clones by refactoring duplicated code into reusable components or shared libraries. By way of an example, consider a scenario where a project includes multiple functions that perform similar tasks but are implemented separately. In such a case, these duplicated code clones may be identified, and it may be suggested to consolidate functionality into reusable components or library. The remediation technique may apply automated code fixes to address identified issues, such as the bugs, the security vulnerabilities, and the performance bottlenecks in the code file.

At step 312, an optimized code file may be generated in response to resolving the one or more potential anomalies in the code file by an optimization module (such as the optimization module 210). The optimized code file may be free from the one or more potential issues. Further, at step 312, the optimized code file may be rendered as a real-time recommendation to the user via a rendering module (such as the rendering module 212). The user may seamlessly access the optimized code file. In some embodiments, a real-time feedback may be received from the user corresponding to the optimized code file during software development in response to rendering the optimized code file.

In some embodiments, the server may be integrated with an Integrated Development Environment (IDE) extension, providing seamless access to code analysis results, and receiving real-time feedback during software development. For example, these plugins enable integration with web browsers, allowing developers to access the code analysis results and provide the real-time feedback while working on web-based code editors and development environments. This integration allows for real-time recommendations and fixes, enabling user 218 to address code issues as they arise during the development process.

By way of an example, consider a scenario where a source code written in programming language includes a class and multiple functions. In such a case, to access detailed analysis at either the file or function level, a user may be provided with options such as summarize code, detect clone, check vulnerabilities, dependency analysis, understand code complexity analysis, code profiling, and perform code refactoring are available. Once an option is selected, results of these activities may be stored in a designated sustenance folder. Each result file may be named using a prefix derived from an original file name, followed by a specific activity name and an appropriate file extension. Additionally, within each file or function, comments may be included at the beginning to establish links between result files and corresponding source files.

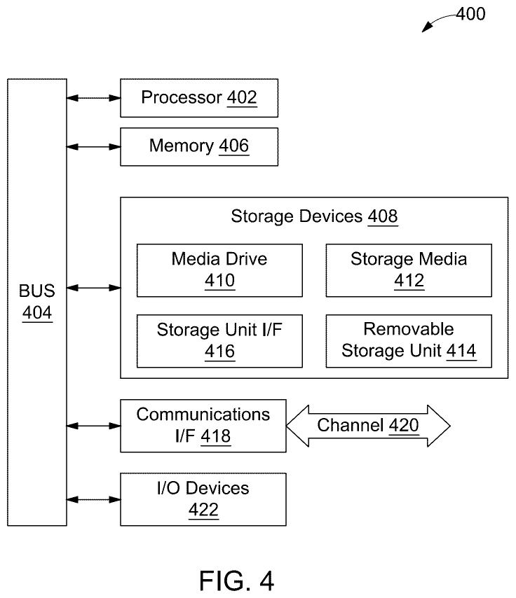

The disclosed methods and systems may be implemented on a conventional or a general-purpose computer system, such as a personal computer (PC) or server computer. Referring now to FIG. 4, an exemplary computing system 500 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 400 may include one or more processors, such as a processor 402 that may be implemented using a general or special purpose processing engine such as, for example, a microprocessor, microcontroller or other control logic. In this example, the processor 402 is connected to a bus 404 or other communication medium. In some embodiments, the processor 402 may be an Artificial Intelligence (AI) processor, which may be implemented as a Tensor Processing Unit (TPU), or a graphical processor unit, or a custom programmable solution Field-Programmable Gate Array (FPGA).

The computing system 400 may also include a memory 406 (main memory), for example, Random Access Memory (RAM) or other dynamic memory, for storing information and instructions to be executed by the processor 402. The memory 406 also may be used for storing temporary variables or other intermediate information during execution of instructions to be executed by the processor 402. The computing system 500 may likewise include a read only memory (“ROM”) or other static storage device coupled to bus 504 for storing static information and instructions for the processor 402.

The computing system 400 may also include a storage devices 508, which may include, for example, a media drive 410 and a removable storage interface. The media drive 410 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 412 may include, for example, a hard disk, magnetic tape, flash drive, or other fixed or removable medium that is read by and written to by the media drive 410. As these examples illustrate, the storage media 412 may include a computer-readable storage medium having stored therein particular computer software or data.

In alternative embodiments, the storage devices 408 may include other similar instrumentalities for allowing computer programs or other instructions or data to be loaded into the computing system 400. Such instrumentalities may include, for example, a removable storage unit 414 and a storage unit interface 416, such as a program cartridge and cartridge interface, a removable memory (for example, a flash memory or other removable memory module) and memory slot, and other removable storage units and interfaces that allow software and data to be transferred from the removable storage unit 414 to the computing system 400.

The computing system 400 may also include a communications interface 518. The communications interface 418 may be used to allow software and data to be transferred between the computing system 400 and external devices. Examples of the communications interface 418 may include a network interface (such as an Ethernet or other NIC card), a communications port (such as for example, a USB port, a micro USB port), Near field Communication (NFC), etc. Software and data transferred via the communications interface 418 are in the form of signals which may be electronic, electromagnetic, optical, or other signals capable of being received by the communications interface 418. These signals are provided to the communications interface 418 via a channel 420. The channel 420 may carry signals and may be implemented using a wireless medium, wire or cable, fiber optics, or other communications medium. Some examples of the channel 420 may include a phone line, a cellular phone link, an RF link, a Bluetooth link, a network interface, a local or wide area network, and other communications channels.

The computing system 400 may further include Input/Output (I/O) devices 522. Examples may include, but are not limited to a display, keypad, microphone, audio speakers, vibrating motor, LED lights, etc. The I/O devices 422 may receive input from a user and also display an output of the computation performed by the processor 402. In this document, the terms “computer program product” and “computer-readable medium” may be used generally to refer to media such as, for example, the memory 406, the storage devices 408, the removable storage unit 414, or signal(s) on the channel 420 These and other forms of computer-readable media may be involved in providing one or more sequences of one or more instructions to the processor 402 for execution. Such instructions, generally referred to as “computer program code” (which may be grouped in the form of computer programs or other groupings), when executed, enable the computing system 400 to perform features or functions of embodiments of the present invention.

In an embodiment where the elements are implemented using software, the software may be stored in a computer-readable medium and loaded into the computing system 400 using, for example, the removable storage unit 414, the media drive 410 or the communications interface 418. The control logic (in this example, software instructions or computer program code), when executed by the processor 402, causes the processor 402 to perform the functions of the invention as described herein.

Various embodiments provide a method and a system for continuous software improvement. The disclosed method and system may receive a plurality of code files related to a plurality of functionalities in a software development lifecycle from a plurality of sources. The disclosed method and system may select a code file from the plurality of code files. The code file may be analyzed based on a plurality of predefined parameters, through a predefined analysis technique and a generative Artificial Intelligence (AI) model. Further, one or more potential anomalies may be identified in the code file based on the analysis. The one or more potential anomalies may be resolved through at least one of a refactorization technique, a clone detection technique, or a remediation technique. Further, an optimized code file may be generated in response to resolving the one or more potential anomalies that may be further rendered file as a real-time recommendation to a user.

The disclosure overcomes the technical problem of continuous software improvement. The disclosure provides an intelligent code sustenance solution. Thus, the disclosure significantly enhances quality, usability, performance, and maintainability of software code files. This enhancement leads to reduced development costs, increased software reliability, and an overall streamlined software development process. The disclosure helps in seamless integration and compatibility with existing Integrated Development Environments (IDEs), and version control systems. The disclosure provides automation to ensure a smooth and efficient code improvement process, maintaining current workflows or require extensive changes to development environments. Additionally, the disclosure provides proactive issue detection and resolution. The disclosure identifies potential code issues and vulnerabilities before they become critical problems. Thus, the disclosure helps allowing developers to address them proactively, reducing the likelihood of software failures, security breaches, and performance bottlenecks. Moreover, the disclosure provides enhanced security and compliance. The disclosure helps organizations in maintaining secure and compliant software code by identifying and remediating security vulnerabilities, ensuring adherence to industry standards and best practices.

The disclosure employs generative AI model and advanced software engineering techniques to identify, analyze, and resolve code issues to ensure superior quality, performance, and maintainability. The disclosure has various applications including real-time code quality assessment, automated security vulnerability detection, code clone elimination, performance bottleneck identification, and legacy system modernization. Further, the disclosure provides seamless integration with the existing IDEs and browser extensions, providing intelligent code sustenance solution that enables developers to prioritize feature development and innovation while consistently upholding high-quality code. Consequently, this leads to reduced development costs, heightened software reliability, and a more streamlined software development process.

The disclosure identifies and remediates security vulnerabilities within a codebase. Further, the disclosure scans for potential vulnerabilities, and automatically applies security patches and best practices to address these issues. Also, the disclosure helps to maintain a secure software product and minimize risk of security breaches effectively. Thus, the disclosure has utility in automated vulnerability detection and remediation.

The disclosure detects and eliminates code clones in software projects. For example, instances of duplicated code which can lead to maintainability and performance issues are identified. Further, the disclosure applies suitable refactoring techniques to eliminate the code clones, improving code quality and reducing maintenance effort and redundancy. Therefore, the disclosure has utility in code clone detection and elimination.

The disclosure automatically summarizes codes, identifies dependencies, and generates document strings (DocStrings). This helps developers understand code structure, functionality, and interconnections, enabling informed decisions while modifying code. This facilitates smooth software evolution, managing complex codebases effectively, and reducing risks associated with updates. Thus, the disclosure has utility in code summarization and identifications of internal/external code dependencies.

The disclosure profiles the codebase and identifies areas where resource utilization can be optimized. By analyzing memory usage, CPU cycles, and other performance metrics, the disclosure helps developers to optimize the code for better resource utilization, ensuring efficient and cost-effective software performance. Thus, the disclosure has utility in automated code profiling for optimized resource utilization.

The disclosure helps developers to understand internal and external dependencies between various components in their software projects. For example, by analyzing a dependency tree, developers may anticipate potential impact of changes in the codebase. This reduces a risk of unintended consequences and ensures a more stable and reliable software system. This helps developers in making well-informed decisions when making modifications to the code. Thus, the disclosure has utility in comprehensive dependency analysis.

The disclosure helps organizations to maintain secure and compliant software code by identifying and remediating security vulnerabilities and ensuring adherence to industry standards and best practices. By continuously monitoring the codebase and applying security patches and best practices, organizations can prevent security breaches, protect sensitive data, and meet regulatory requirements.

The disclosure helps reduce technical debt proactively in projects. The disclosure identifies areas of the codebase with high complexity, the code clones, and potential vulnerabilities, allowing developers to address these issues before they become critical problems. This helps to minimize technical debt, reducing the long-term costs and risks associated with maintaining and evolving software systems. Thus, the disclosure has utility in proactive technical debt reduction.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for continuous software improvement. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of continuous software improvement, the method comprising:
receiving, by a server, a plurality of code files related to a plurality of functionalities in a software development lifecycle from a plurality of sources, wherein each of the plurality of code files comprises code snippets;
selecting, by the server, a code file from the plurality of code files, wherein the code file is related to a functionality of the plurality of functionalities;
analyzing, by the server, the code file based on a plurality of predefined parameters, through a predefined analysis technique and a generative Artificial Intelligence (AI) model, wherein the plurality of pre-defined parameters comprises a documentation scrutiny, a code complexity, an impact of code change, and a security compliance verification;
identifying, by the server, one or more potential anomalies in the code file based on the analysis;
resolving, by the server, the one or more potential anomalies through at least one of a refactorization technique, a clone detection technique, or a remediation technique;
generating, by the server, an optimized code file in response to resolving the one or more potential anomalies; and
rendering, by the server, the optimized code file as a real-time recommendation to a user.

2. The method of claim 1, wherein the plurality of sources comprises local files, code repositories, cloud-based repositories, collaborative platforms, documentation platforms, continuous integration or delivery systems, knowledge bases, and document stores.

3. The method of claim 1, further comprising:
storing the plurality of code files in at least one of a plurality of pre-defined formats, wherein the plurality of pre-defined formats comprises a searchable format for a text-based analysis and an embedded format for a similarity and clustering analysis.

4. The method of claim 1, wherein analyzing the code file comprises:
scanning the code file; and
generating one or more of summaries, comments, and dependency trees based on the scanning.

5. The method of claim 1, wherein the pre-defined analysis technique comprises at least one of a static analysis technique or a dynamic analysis technique.

6. The method of claim 1, wherein the one or more potential anomalies comprise code clones, performance bottlenecks, bugs, security vulnerabilities, concurrency issues, memory leaks, unused variables, and resource contentions.

7. The method of claim 1, further comprising integrating the server with an Integrated Development environment (IDE) extension.

8. The method of claim 1, further comprising receiving a real-time feedback from the user corresponding to the optimized code file during software development in response to rendering the optimized code file.

9. The method of claim 1, wherein:
the documentation scrutiny corresponds to analyzation of documentation strings within the code file with respect to standard guidelines;
the code complexity corresponds to a level of intricacy in understanding, maintaining, and modifying the code file;
the impact of code change corresponds to a potential effect of modification in the code file on other code files; and
the security compliance verification corresponds to verification of the code file for potential security vulnerabilities and licenses of software components used in the code file.

10. A system of continuous software improvement, the system comprising:
a processor; and
a memory communicatively coupled to the processor, wherein the memory stores processor instructions, which when executed by the processor, cause the processor to:
receive a plurality of code files related to a plurality of functionalities in a software development lifecycle from a plurality of sources, wherein each of the plurality of code files comprises code snippets;
select a code file from the plurality of code files, wherein the code file is related to a functionality of the plurality of functionalities;
analyze the code file based on a plurality of predefined parameters, through a predefined analysis technique and a generative Artificial Intelligence (AI) model, wherein the plurality of pre-defined parameters comprises a documentation scrutiny, a code complexity, an impact of code change, and a security compliance verification;
identify one or more potential anomalies in the code file based on the analysis;
resolve the one or more potential anomalies through at least one of a refactorization technique, a clone detection technique, or a remediation technique;
generate an optimized code file in response to resolving the one or more potential anomalies; and
render the optimized code file as a real-time recommendation to a user.

11. The system of claim 10, wherein the plurality of sources comprises local files, code repositories, cloud-based repositories, collaborative platforms, documentation platforms, continuous integration or delivery systems, knowledge bases, and document stores.

12. The system of claim 10, wherein the processor-executable instructions further cause the processor to:
store the plurality of code files in at least one of a plurality of pre-defined formats, wherein the plurality of pre-defined formats comprises a searchable format for a text-based analysis and an embedded format for a similarity and clustering analysis.

13. The system of claim 10, wherein the processor-executable instructions further cause the processor to analyze the code file by:
scanning the code file; and
generating one or more of summaries, comments, and dependency trees based on the scanning.

14. The system of claim 10, wherein the pre-defined analysis technique comprises at least one of a static analysis technique or a dynamic analysis technique.

15. The system of claim 10, wherein the one or more potential anomalies comprise code clones, performance bottlenecks, bugs, security vulnerabilities, concurrency issues, memory leaks, unused variables, and resource contentions.

16. The system of claim 10, wherein the processor-executable instructions further cause the processor to integrate the server with an Integrated Development environment (IDE) extension.

17. The system of claim 10, wherein the processor-executable instructions further cause the processor to receive a real-time feedback from the user corresponding to the optimized code file during software development in response to rendering the optimized code file.

18. The system of claim 10, wherein:
the documentation scrutiny corresponds to analyzation of documentation strings within the code file with respect to standard guidelines;
the code complexity corresponds to a level of intricacy in understanding, maintaining, and modifying the code file;
the impact of code change corresponds to a potential effect of modification in the code file on other code files; and
the security compliance verification corresponds to verification of the code file for potential security vulnerabilities and licenses of software components used in the code file.

19. A non-transitory computer-readable medium storing computer-executable instructions of continuous software improvement, the computer-executable instructions configured for:
receiving a plurality of code files related to a plurality of functionalities in a software development lifecycle from a plurality of sources, wherein each of the plurality of code files comprises code snippets;
selecting a code file from the plurality of code files, wherein the code file is related to a functionality of the plurality of functionalities;
analyzing the code file based on a plurality of predefined parameters, through a predefined analysis technique and a generative Artificial Intelligence (AI) model, wherein the plurality of pre-defined parameters comprises a documentation scrutiny, a code complexity, an impact of code change, and a security compliance verification;
identifying one or more potential anomalies in the code file based on the analysis;
resolving the one or more potential anomalies through at least one of a refactorization technique, a clone detection technique, or a remediation technique;
generating an optimized code file in response to resolving the one or more potential anomalies; and
rendering the optimized code file as a real-time recommendation to a user.

20. The non-transitory computer-readable medium of claim 19, wherein the computer-executable instructions are further configured for:
storing the plurality of code files in at least one of a plurality of pre-defined formats, wherein the plurality of pre-defined formats comprises a searchable format for a text-based analysis and an embedded format for a similarity and clustering analysis.
